(19) United States
(12) Patent Application Publication
(10) Pub. No.: US 2025/0128348 A1
(43) Pub. Date: Apr. 24, 2025

(54) LASER-PROCESSING MACHINE WITH A FREQUENCY-COMB-BASED DISTANCE SENSOR AND ASSOCIATED METHOD WITH FREQUENCY-COMB-BASED DISTANCE MEASUREMENT

(71) Applicant: TRUMPF Laser GmbH, Schramberg (DE)

(72) Inventors: Jan-Patrick Hermani, Markgröningen (DE); Matthias Hartmann, Schramberg (DE); Sebastian Neudeck, Schramberg (DE); Patrick Haug, Unteriflingen (DE)

(21) Appl. No.: 19/007,603

(22) Filed: Jan. 2, 2025

Related U.S. Application Data
(63) Continuation of application No. PCT/EP2023/064016, filed on May 25, 2023.

(30) Foreign Application Priority Data
Jul. 7, 2022 (DE) 10 2022 116 927.8

(51) Int. Cl. B23K 26/03; B23K 26/044; B23K 26/082

(52) U.S. Cl. CPC B23K 26/032; B23K 26/044; B23K 26/082

(57) ABSTRACT

A laser processing machine for laser processing a workpiece by a processing laser beam includes a laser beam generator for generating the processing laser beam, a processing optical unit for directing the processing laser beam onto the workpiece, and a frequency-comb-based distance sensor. The distance sensor includes a laser source that is fed back in a frequency-shifted manner for generating a sensor laser beam with a frequency comb that spectrally shifts over time. The sensor laser beam is divided into a measurement beam and a reference beam along a measurement path and a reference path, respectively. The distance sensor further includes a detector, and an evaluation device configured to ascertain a distance value based on a frequency difference, resulting from a time-of-flight difference of the measurement beams and the reference beams superimposed on the detector, of two frequency combs originating from the measurement path and the reference path.

### CROSS REFERENCE TO RELATED APPLICATIONS

This application is a continuation of International Application No. PCT/EP2023/064016 (WO 2024/008363 A1), filed on May 25, 2023, and claims benefit to German Patent Application No. DE 10 2022 116 927.8, filed on Jul. 7, 2022. The aforementioned applications are hereby incorporated by reference herein.

### FIELD

Embodiments of the present invention relate to a laser processing machine for laser processing at least one workpiece by means of a processing laser beam and having a laser beam generator for generating the processing laser beam, having a processing optical unit for directing the processing laser beam onto the at least one workpiece. Embodiments of the invention also relate to a method for detecting geometric features on at least one workpiece during laser processing.

### BACKGROUND

Such a laser processing machine with an additional interferometric distance measurement in the form of a scanning OCT (optical coherence tomography) distance sensor has become known, for example, from DE 10 2019 132 619 A2 or DE 10 2020 203 983 A1.

Measuring distances for determining geometric workpiece features (joining positions, weld depth, seam geometry) is a central requirement for sensors for monitoring laser welding processes. OCT distance sensors with a reference path (reference arm) that can be readjusted in a motorized manner and is embodied in the form of an additional component have become established for this in recent years. The OCT distance sensor, which is the size of a shoe box, is usually arranged in a control cabinet and is fibre-connected to the processing optical unit. The reference arm is either integrated in the OCT sensor or is remote from the processing optical unit close to an OCT scanner. Path length differences of single-digit micrometres can be resolved only in the case of a reduction in the measurement range, that is to say flexible adaptation of resolution and measurement range is not possible, but rather requires a hardware change of the OCT distance sensor.

However, the use of OCT distance sensors for the interferometric distance measuring apparatus in laser processing machines can have the following disadvantages:
adjustable reference arm necessary on account of the only very small measurement range (of only approximately 12 mm);
z-resolution is insufficient for the z-resolution of less than 12 μm, for example 1 μm or sub-μm range, required in the laser processing of thin metal sheets, for example having a thickness of 50 μm or 100 μm;
not possible to be integrated into the processing optical unit, but requires a complex and expensive spectrometer construction with free-beam optical unit.

### SUMMARY

Embodiments of the present invention provide a laser processing machine for laser processing at least one workpiece by a processing laser beam. The laser processing machine includes a laser beam generator for generating the processing laser beam, a processing optical unit for directing the processing laser beam onto the at least one workpiece, and a frequency-comb-based distance sensor for measuring distances for determining geometric features of the at least one workpiece. The frequency-comb-based distance sensor includes a laser source that is fed back in a frequency-shifted manner for generating a sensor laser beam with a frequency comb that spectrally shifts over time. The sensor laser beam is divided into a measurement beam and a reference beam along a measurement path and a reference path, respectively. The frequency-comb-based distance sensor further includes a detector, on which returning measurement beams and returning reference beams are superposed, and an evaluation device configured to ascertain a distance value based on a frequency difference, resulting from a time-of-flight difference of the returning measurement beams and the returning reference beams, of two frequency combs originating from the measurement path and the reference path.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically shows a first embodiment of a laser processing machine having a fixed optical unit for a processing laser beam and having a frequency-comb-based distance sensor; and

FIG. 2 schematically shows a second embodiment of a laser processing machine having a programmable focusing optical unit for a processing laser beam and having a frequency-comb-based distance sensor.

### DETAILED DESCRIPTION

Embodiments of the present invention provide a laser processing machine and a method. so that the abovementioned disadvantages can be overcome.

According to embodiments of the invention, a frequency-comb-based distance sensor having a laser source which is fed back in a frequency-shifted manner for generating a sensor laser beam having a frequency comb that spectrally shifts over time, having a measurement path and a reference path (also referred to as measurement arm and reference arm, respectively), over which the sensor laser beam is divided into a measurement beam and a reference beam, having a detector on which returning measurement beams and reference beams are superposed, and having an evaluation device, which ascertains a distance value on the basis of the frequency difference, resulting from a time-of-flight difference between the measurement beams and reference beams, of the two frequency combs originating from the measurement path and reference path.

The frequency combs are preferably cw (continuous wave) frequency combs, but pulsed frequency combs are also possible.

Frequency-comb-based distance measurements are known in principle and are described, for example, in DE 10 2012 001 754 A1, WO 03/061084 A1, WO 2018/005987 A1 and JP 2021-021744 A1.

In the frequency-comb-based distance measurement according to embodiments of the invention by means of a laser source which is fed back in a frequency-shifted manner (Frequency-Shifted-Feedback Ranging=FSF Ranging), a frequency comb with frequency comb teeth that spectrally shift over time is split in an interferometric structure into the measurement paths and reference paths, which have different optical path lengths. The light returning from the measurement and reference paths is superposed at the detector. In the process, the frequency difference of the two frequency combs resulting from the time-of-flight difference results in a beat frequency, from which the path length difference between the measurement path and the reference path, that is to say a relative distance value or, if the reference path is known, an absolute distance value, can then be derived.

In the case of the frequency-comb-based distance measurement, mechanical tracking of the reference arm can be dispensed with on account of the large uniqueness range for the maximum path differences (approximately 150 mm to 200 mm) that can be expected during the laser processing process.

For laser material processing, the frequency-comb-based distance measurement offers considerable advantages because of the large axial measurement range simultaneously with a high axial resolution of 1 μm into the sub-μm range. Furthermore, there are advantages in terms of the signal quality since the signal strength does not decrease quadratically with the measurement distance but only with a linear profile. The proposed distance sensor system can be employed for a wide variety of purposes in laser processing, primarily in laser welding processes for seam position control, weld depth measurement, subsequent seam quality assessment and focus position control; in microprocessing for highly accurate surface (structure) control, for controlling the layer removal between individual removal steps and generally, for example, for component position detection and shape recognition and associated therewith an adaptive adaptation and alignment of a geometry to be processed. Also conceivable are applications in generative manufacturing (LMF/LMD), for example layer thickness measurement, detection of the component position during generation on existing components.

The suitability of the frequency-comb-based distance measurement according to embodiments of the invention was confirmed in weld depth measurement tests: The frequency-comb-based distance measurement is robust with respect to the stray light of the process emission and is capable of capturing distance values with sub-μm resolution from the vapour capillary during laser processing.

The frequency-comb-based distance measurement according to embodiments of the invention results in particular in the following advantages over conventional OCT distance measurement:
completely dispensing with mechanical readjustment of the reference path (reference arm) is possible, as a result of which no measurement pauses and no actuator system which is susceptible to wear are required and lower costs are possible;
no reference arm remote from the frequency-comb-based distance sensor is required;
higher resolution than with the OCT distance sensor, currently in the sub-μm range;
use for microprocessing possible;
independence of resolution and measurement range, i.e. a high resolution is also possible in the case of a large measurement range; e.g. measurement ranges of 300 mm at resolutions of 100 nm. In this case, the measurement range is settable by way of software.
arbitrarily defining a small measurement window within a large uniqueness range; as a result, increasing the measurement rate, blocking out artifacts;
linear instead of quadratic signal drop over the measurement distance;
higher signal-to-noise ratio, larger measurement range in the case of defocusing;
no spectrometer with free-beam optical unit is required;
cost-effective detector (diode instead of image line) with simpler data evaluation;
greatly enlarged measurement range up to several metres by cascading uniqueness ranges.

The frequency-comb-based distance sensor preferably has an additional seed laser source for generating injection laser light, the phase of which is modulated with a time-variable frequency. The laser source fed back in a frequency-shifted manner is provided with the injection laser light, as a result of which a strong intensity increase of the beat signal and a greatly improved separation sharpness are achieved at a characteristic modulation frequency. Since the characteristic modulation frequency changes with the path length difference between the measurement arm and the reference arm, it can also be attributed to a distance value. The corresponding characteristic modulation frequency is ascertained in the case of an unknown distance by recording the RMS (root mean square) signal of the detector over the known time profile of the impressed phase modulation: The modulation frequency at which the RMS signal becomes maximal is the frequency that can be attributed to the distance, as a result of which the distance can be determined with sufficiently high accuracy.

The frequency-comb-based distance measurement is able to sample a reduced section of the uniqueness range for distance values on the basis of a measurement window and to increase the measurement rate as a result of the reduction in the phase modulation range associated therewith. At the same time, interference signals (unwanted reflections) can be blocked out by appropriate positioning of the measurement window. In order to define the measurement window position, the measurement method requires, as input, an expected value of the phase modulation frequency or of the distance which corresponds to the path length difference between the measurement object (workpiece) and the reference object (e.g. protective glass). Depending on the nature of the data preprocessing in the frequency-comb-based distance sensor, only one distance value or an entire distance value spectrum along the measurement axis (delimited by the measurement window) is recorded for an individual measurement. The data are post-processed and evaluated in accordance with their complexity (point measurement or scanning line measurement). In the simplest case, this can be carried out directly in a machine control system; in the complex case, an image processing PC or a high-performance graphics card is required for this purpose.

The size of the uniqueness range furthermore makes it possible (in some cases in conjunction with the possibility of cascading uniqueness ranges along the measurement axis) to make the reference path a constituent part of the measurement path. The reference path is therefore preferably completely contained in the measurement path, that is to say the reference arm is completely integrated into the measurement arm, with the result that a temperature drift of the measurement arm and of the reference arm is identical and consequently cancels out. Moreover, this measure allows a smaller sensor size.

In the simplest case, the end of a measuring fibre is used as the reference plane. In a preferred embodiment of the laser processing machine, an optical element is arranged in the beam path of the sensor laser beam, with the side of said optical element facing the frequency-comb-based distance sensor having a reflectivity for the sensor laser beam of at least 1%, preferably of at least 5%, in order to allow the sensor laser beam to pass through as a measurement beam and to be reflected as a reference beam. Instead of minimizing the reflectivity of an optical element for the sensor laser beam, as is conventional for reducing radiation losses, the reflectivity of the optical element is increased according to the embodiments of the invention in order to use the component of the sensor laser beam that is reflected at the optical element as a reference beam. Such a construction is not possible with conventional OCT approaches, since the path length difference between the optical element in the beam path and the workpiece cannot be compensated. In an advantageous development of this embodiment, the optical element is formed by a protective glass, by a focus lens of the processing optical unit or by a fibre end of a fibre used jointly for the measurement and reference beams.

The processing optical unit preferably has a processing scanner (macroscanner), for example in the form of a galvanometer with mirrors, in order to be able to deflect the processing laser beam in one dimension or two dimensions on the at least one workpiece.

In a preferred embodiment of the laser processing machine, a mirror is arranged both in the beam path of the processing laser beam and in the beam path of the sensor laser beam, said mirror aligning the processing laser beam and the sensor laser beam coaxially with respect to each other. The mirror can be, for example, an inclined beam splitter mirror, which is reflective for the processing laser beam and transmissive for the sensor laser beam, or vice versa, or a scraper mirror, pinhole mirror, etc. In an advantageous development of this embodiment, a sensor scanner (microscanner) is arranged between the frequency-comb-based distance sensor and the mirror, said sensor scanner deflecting the sensor laser beam in one or two dimensions in order to sample the at least one workpiece. The sensor scanner is thus disposed upstream of the processing scanner in order to enable a relative movement between the measurement beam and the processing laser beam.

Advantageously, the frequency-comb-based distance sensor is embodied at least partially, in particular exclusively, in a fibre-optical unit, which makes a compact sensor construction and high robustness against mechanical vibrations and shocks, and also a compact design possible. In contrast to OCT, the frequency-comb-based distance measurement does not require a space-requiring interferometer structure. In conjunction with the already described omission of a separate reference arm and the principle-related embodiment in a compact fibre-optical unit, this allows space-saving integration into laser processing optical units. For higher measurement rates and a highly integrated design, the frequency-comb-based distance sensor can alternatively also be embodied as a silicon-based photonic circuit.

Preferably, the frequency-comb-based distance sensor is mounted on the processing optical unit or integrated into the processing optical unit, in particular if embodied in a fibre-optical unit. An additional expensive sensor control cabinet is therefore no longer required. The frequency-comb-based distance sensor is, for example, a highly integrated hardware module which can be screwed to or into the processing optical unit in a modular manner. Alternatively, however, the frequency-comb-based distance sensor can also be arranged in the laser device or in a separate control cabinet. In this case, the measurement light must be guided to the processing optical unit by way of a fibre parallel to the light-guiding cable of the processing laser. The measurement light can also be guided to the processing optical unit in the fibre of the processing laser, but sufficient spectral separation of the two light components must be present for this.

The frequency-comb-based distance sensor can be attached directly to the processing optical unit or alternatively can also be integrated in a laser device remote from the processing optical unit, wherein in this case the sensor laser beam and the processing laser beam are guided from the laser device to the processing optical unit via a common fibre. Since the distance sensor may already have a fibre for guiding the measurement/reference radiation, it could coincide with the fibre which serves for guiding the processing laser radiation from the laser device to the optical unit. In this case, for example, the common fibre can be embodied at its end to be slightly reflective for the sensor laser beam of the distance sensor so that said fibre also constitutes the reference path.

Embodiments of the invention also relate to a method for detecting geometric (depth) features on at least one workpiece during laser processing by means of a laser processing machine as described above, wherein the measurement beam of the frequency-comb-based distance sensor is directed onto a geometric feature of the workpiece and a distance value or a depth of the geometric feature is ascertained on the basis of the frequency difference, resulting from a time-of-flight difference between the measurement and reference beams, of the two frequency combs originating from the measurement path and the reference path. A corresponding depth profile of the geometric feature can be obtained by scanning the geometric feature in one or two dimensions by means of the measurement beam. The geometric feature may be, for example, the joining position, welding depth or seam geometry during laser welding.

It is possible for the abovementioned features and the features mentioned below to be used individually by themselves or for multiple features to be used in any desired combinations. The embodiments shown and described below should not be understood as an exhaustive list.

In the following description of the drawing, identical reference signs are used for identical or functionally identical components.

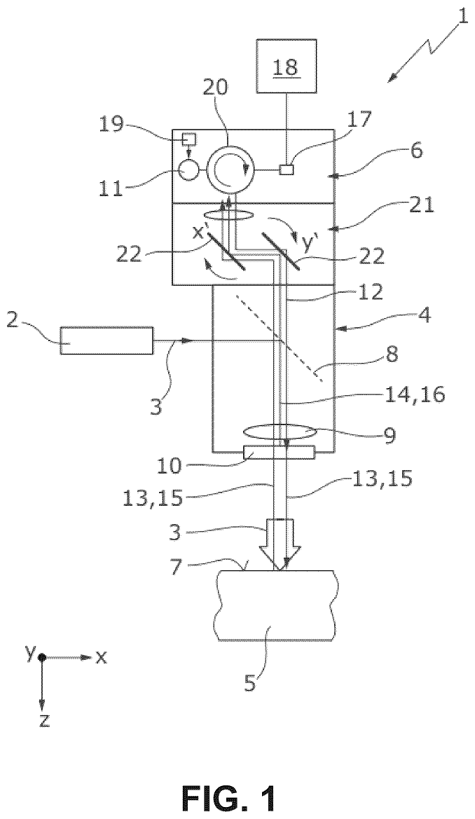

The laser processing machine 1 schematically shown in FIG. 1 has a laser beam generator 2 for generating a processing laser beam 3, a processing optical unit 4, here in the form of a fixed optical unit, for directing the processing laser beam 3 onto a workpiece 5, and a frequency-comb-based distance sensor 6 for interferometrically measuring distances in order to determine geometric features (joining positions, welding depth, seam geometry during laser welding) on the workpiece surface 7 of the workpiece 5.

The processing optical unit 4 comprises an inclined mirror 8, which is reflective for the processing laser beam 3 and at which the processing laser beam 3 is deflected by 90°, and a focusing lens 9 for focusing the deflected processing laser beam 3 onto the workpiece 5, and a protective glass 10, through which the focused processing laser beam 3 emerges from the fixed optical unit 4.

The frequency-comb-based distance sensor 6 has, in a known manner, a laser source (frequency comb generator) 11 which is fed back in a frequency-shifted manner for generating a sensor laser beam 12 with a cw frequency comb shifting spectrally over time, a measurement path 13 and a reference path 14, over which the sensor laser beam 12, as described below, is divided into a measurement beam 15 and a reference beam 16, a detector 17, on which returning measurement beams 15 and reference beams 16 are superposed, and an evaluation device 18, which ascertains a distance value on the basis of the frequency difference, resulting from a time-of-flight difference of the measurement beams 15 and reference beams 16, of the frequency combs of the returning measurement beams 15 and reference beams 16. The sensor laser beam 12 is accordingly a laser beam which is generated in the distance sensor 6. Optionally, the distance sensor 6 may also have an additional seed laser source 19 for generating injection laser light, with which the laser source 11 which is fed back in a frequency-shifted manner is provided. In this case, the phase of the injection laser light is modulated with a time-variable frequency. An optical circulator 20 serves to guide the light emitted by the laser source 11 onto the workpiece 5 and the back-reflected measurement beams 15 and reference beams 16 onto the detector 17. The optical circulator 20 is, for instance, a single-mode fibre-optic circulator.

A sensor scanner 21 is connected to the distance sensor 6 in order to deflect the sensor laser beam 12 on the workpiece surface 7 in one or two dimensions, that is to say in the x-direction and/or y-direction, and to thus scan a region of the workpiece surface 7, for example with line scans. By way of example, the sensor scanner 21 can have a scanner mirror that is deflectable about two axes or, as shown in FIG. 1, two scanner mirrors 22 that are each deflectable about one axis.

Using the inclined mirror 8, which is transmissive for the sensor laser beam 12, the sensor laser beam 12 is coupled into the processing optical unit 4 coaxially with respect to the processing laser beam 3 and is directed onto the workpiece 5 through the focus lens 9 and the protective glass 10. The side of the protective glass 10 facing the distance sensor 6 has a reflectivity of at least 1%, preferably approximately 5%, for the sensor laser beam 12 in order to thus split the sensor laser beam 12 at the protective glass 10 into the transmitted measurement beam 15 and the reflected reference beam 16. The measurement beam 15 is reflected at the workpiece surface 7 and travels back to the distance sensor 6 via the processing optical unit 4 and the sensor scanner 21. The optical path travelled overall by the sensor laser beam 12 and, after it has been split, by the measurement beam 15 defines the measurement path 13, and the optical path travelled overall by the sensor laser beam 12 and, after it has been split, by the reference beam 16 defines the reference path 14. The reference path 14 is thus completely contained in the measurement path 13.

In the frequency-comb-based distance measurement, by means of the laser source which is fed back in a frequency-shifted manner (Frequency-Shifted-Feedback Ranging=FSF Ranging) 11, a cw frequency comb with frequency comb teeth that spectrally shift over time is split in an interferometric structure into the measurement path 13 and the reference path 14, which have different optical path lengths. The measurement beams 15 and reference beams 16 returning from the measurement path 13 and the reference path 14 are superposed at the detector 17. In the process, the frequency difference, resulting from the time-of-flight difference, of the cw frequency combs of the measurement beams 15 and the reference beams 16 results in a beat frequency, from which the path length difference between the measurement path 13 and the reference path 14, that is to say a relative distance value or, if the reference path 14 is known, an absolute distance value, can be derived by the evaluation unit 18. However, the distance information is only diffuse in the beat frequency spectrum, and the distance determination is accordingly inaccurate. If the laser source 11, which is fed back in a frequency-shifted manner, is provided with the additional injection light from the seed laser source 19, the phase of which is modulated with a time-variable frequency, a strong intensity increase of the beat signal and a greatly improved separation sharpness are achieved at a characteristic modulation frequency. Since the characteristic modulation frequency changes with the path length difference between the measurement path 13 and the reference path 14, it can also be attributed to a distance value. The corresponding characteristic modulation frequency is ascertained with the distance unknown by recording the RMS signal of the detector 17 over the known time profile of the impressed phase modulation: The modulation frequency at which the RMS signal becomes maximal is the frequency attributable to the distance.

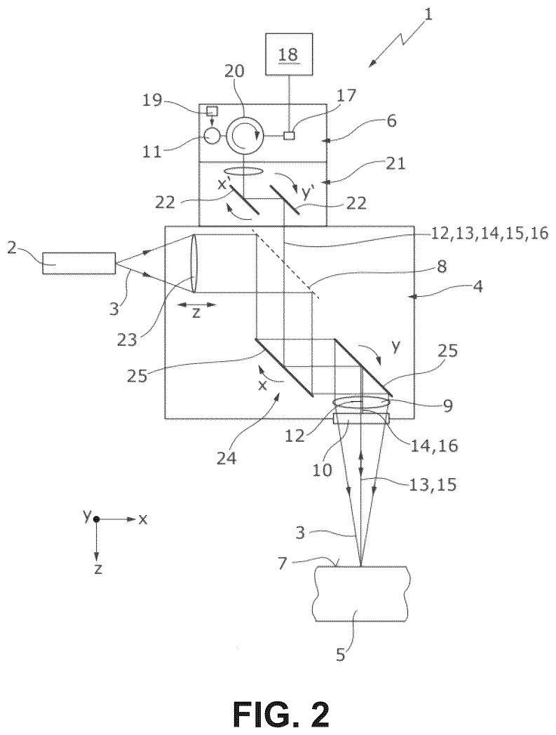

The laser processing machine 1 shown in FIG. 2 differs from the laser processing machine 1 of FIG. 1 in that the processing optical unit 4 is embodied not as a fixed optical unit but as a programmable focusing optical unit. The programmable focusing optical unit is a 2-axis laser scanner (x-y), which may optionally also have a collimation lens 23 that is displaceable along the beam axis (z). The collimation lens 23 is arranged upstream of the mirror 8 in the beam path of the processing laser beam 3, as a result of which the focus of the processing laser beam 3 can be shifted along the beam direction z. In addition, the processing optical unit 4 has a processing scanner 24 between the mirror 8 and the focus lens 9 in order to deflect the processing laser beam 3—and thus also the sensor laser beam 12—on the workpiece surface 7 in one or two dimensions, that is to say in the x-direction and/or y-direction. By way of example, the processing scanner 24 can have a scanner mirror that is deflectable about two axes or, as shown in FIG. 2, two scanner mirrors 25 that are each deflectable about one axis. As is further shown in FIG. 2, the sensor laser beam 12 or the measurement beam 15 can be deflected with respect to the processing laser beam 3 and independently of the processing laser beam 3 using the sensor scanner 21 in order, for example, to measure the workpiece surface 7 in advance and subsequently of the welding position of the processing laser 3.

The suitability of the frequency-comb-based distance measurement was confirmed on the basis of weld depth measurement tests: The frequency-comb-based distance measurement is robust with respect to the stray light of the process emission and is capable of capturing distance values with sub-μm resolution from the vapour capillary (keyhole) during the laser welding processing.

Instead of the cw frequency combs described in FIGS. 1 and 2, pulsed frequency combs can alternatively also be used.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A laser processing machine for laser processing at least one workpiece by a processing laser beam, the laser processing machine comprising:
a laser beam generator for generating the processing laser beam,
a processing optical unit for directing the processing laser beam onto the at least one workpiece, and
a frequency-comb-based distance sensor for measuring distances for determining geometric features of the at least one workpiece, wherein the frequency-comb-based distance sensor comprises:
a laser source that is fed back in a frequency-shifted manner for generating a sensor laser beam with a frequency comb that spectrally shifts over time, wherein the sensor laser beam is divided into a measurement beam and a reference beam along a measurement path and a reference path, respectively,
a detector, on which returning measurement beams and returning reference beams are superposed, and
an evaluation device configured to ascertain a distance value based on a frequency difference, resulting from a time-of-flight difference of the returning measurement beams and the returning reference beams, of two frequency combs originating from the measurement path and the reference path.

2. The laser processing machine according to claim 1, wherein the frequency-comb-based distance sensor further comprises a seed laser source for generating injection laser light, wherein a phase of the injection laser light is modulated with a time-variable frequency, and wherein the laser source which is fed back in the frequency-shifted manner is provided with the injection laser light.

3. The laser processing machine according to claim 1, wherein the reference path is completely contained in the measurement path.

4. The laser processing machine according to claim 1, further comprising an optical element arranged in a beam path of the sensor laser beam, wherein a side of the optical element facing the frequency-comb-based distance sensor has a reflectivity for the sensor laser beam of at least 1% in order to divide the sensor laser beam into the measurement beam and the reference beam, wherein the measurement beam is transmitted through the optical element, and the reference beam is reflected by the optical element.

5. The laser processing machine according to claim 4, wherein the optical element comprises a protective glass, a focus lens of the processing optical unit, or a fibre end of a fibre used jointly for the measurement beams and the reference beams.

6. The laser processing machine according to claim 1, wherein the processing optical unit comprises a processing scanner for deflecting the processing laser beam in one or two dimensions on the at least one workpiece.

7. The laser processing machine according to claim 1, further comprising a mirror arranged in a beam path of the processing laser beam and in a beam path of the sensor laser beam, wherein the mirror is configured to align the processing laser beam and the sensor laser beam coaxially with respect to each other.

8. The laser processing machine according to claim 7, further comprising a sensor scanner arranged between the frequency-comb-based distance sensor and the mirror, wherein the sensor scanner is configured to deflect the sensor laser beam in one or two dimensions, in order to sample the at least one workpiece.

9. The laser processing machine according to claim 1, wherein the frequency-comb-based distance sensor is embodied at least partially in a fibre-optic unit or as a silicon-based photonic circuit.

10. The laser processing machine according to claim 1, wherein the frequency-comb-based distance sensor is mounted on the processing optical unit or is integrated into the processing optical unit.

11. The laser processing machine according to claim 1, wherein the frequency-comb-based distance sensor is integrated in a laser device remote from the processing optical unit, and wherein the sensor laser beam and the processing laser beam are guided from the laser device to the processing optical unit via a common fibre.

12. A method for detecting geometric features on at least one workpiece during laser processing by a laser processing machine according to claim 1, wherein the measurement beam of the frequency-comb-based distance sensor is directed onto a geometric feature of the workpiece and a distance value of the geometric feature is ascertained based on the frequency difference, resulting from the time-of-flight difference between the measurement beams and reference beams, of the frequency combs of the measurement beams and the reference beams.

13. The method according to claim 12, wherein the geometric feature is scanned in one or two dimensions.
